(19) United States
(12) Patent Application Publication
(10) Pub. No.: US 2007/0081108 A1
(43) Pub. Date: Apr. 12, 2007

(54) Array substrate and its manufacturing method

(75) Inventor: Ichiro Tsukada, Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TFPD CORPORATION, HYOGO (JP)

(21) Appl. No.: 10/509,021

(22) PCT Filed: Mar. 24, 2003
(86) PCT No.: PCT/JP03/03544

§ 371 Date: Apr. 11, 2005

(30) Foreign Application Priority Data
Mar. 26, 2002 (JP) 2002-86972

(51) Int. Cl. G02F 1/1333

(52) U.S. Cl. 349/54

(57) ABSTRACT

An array substrate for a flat-panel display device and manufacturing method thereof, enabling a reliable repairing of a wire breakage within a pixel area, irrespective of nature of the wire breakage, especially irrespective of nature, dimensions and shape of a foreign matter causing the wire breakage. For example, when the wire breakage due to foreign matter is formed on a signal line, the foreign matter is removed and then a bypass wire detouring the wire breakage is formed by laser CVD technique. On beforehand, a rectangular cutout is formed on a neighboring pixel electrode by laser irradiation; and contact holes for exposing upper faces of two wire parts of the signal line as separated by the wire breakage. After forming angled-C shaped bypass wire along edges of the cutout on the pixel electrode, a light insulator film is formed at inside of the bypass wire by laser CVD technique.

### FIELD OF THE INVENTION

This invention relates to an array substrate for flat-panel display devices or the like and typically for liquid-crystal display devices; and more specifically to those in which a disconnected or malfunctioned wire is repaired or corrected as to curb line-shaped display defects due to wire breakage within a pixel area. This invention also relates to a method of manufacturing such array substrate.

### BACKGROUND ART

Recently, liquid crystal display devices and other flat-panel display devices are used in various fields as image display devices for personal computers, word processor-dedicated machines, television set or the like as well as for a projector display device; in view of their small depth dimension and small weight as well as small electric power consumption.

Active-matrix liquid crystal display (active-matrix LCD) devices in particular, which has pixel-switching elements arranged on each display pixel, enables to achieve good image quality without crosstalk between adjacent pixels. Because of these features, active matrix liquid crystal display devices are being earnestly investigated and developed.

In following, a light transmissive type device of the active-matrix LCD device is exemplified for explaining its construction.

An active-matrix LCD device is comprised of a matrix array substrate (hereinafter referred as array substrate) and a counter substrate, which are closely opposed to each other with a predetermined gap, and of a liquid crystal layer held in the gap.

The array substrate has signal lines and scanning lines, which are arranged in a latticework on an insulator substrate such as a glass plate, and are superimposed through an insulator film therebetween. On each rectangular patch defined by the signal and scanning lines, a pixel electrode is disposed and formed of a transparent electro-conductive material such as Indium-doped tin oxide (ITO). At around each crossing of the signal and scanning lines, a pixel-switching element is disposed for controlling a respective pixel electrode. When the pixel-switching element is a thin film transistor (TFT), gate and signal electrodes of the TFT are respectively connected with scanning and signal lines; and a source electrode of the TFT is connected with a pixel electrode.

The counter substrate has a counter electrode formed of a transparent electro-conductive material such as Indium-doped tin oxide (ITO), on an insulator substrate such as a glass plate. When to realize color display, color filter layers are formed on the substrate.

In view of reducing cost of manufacturing such active-matrix LCD, the array substrate requires many process steps and thus takes up high percentage of total manufacturing cost.

In a structure proposed in JP-09(1997)-160076A (Japanese Patent Appln. No. 8-260572), the pixel electrodes are arranged at uppermost layer so that the signal lines and source and drain electrodes as well as semiconductive coating layer are simultaneously patterned under single mask pattern. Subsequently, source-electrode contact holes for respectively and electrically connecting the source and pixel electrodes are formed simultaneously with formation of peripheral contact holes that are for exposing contact terminals of the signal and scanning lines.

On manufacturing of the array substrate, there occasionally occurs cases in which a foreign matter or contaminant adheres on a wire at a time of its formation; or in which a pinhole is formed on a resist pattern due to a foreign matter or contaminant at a time of light exposure process. These cause a disconnection of the wire. Such disconnection of the signal line or the scanning line causes a display defect extending in a line as to eventually increase proportion of defective products that are not eligible for shipping, and consequently causing increase of manufacturing cost of the array substrate.

In view of the above, various ways of repairing are attempted. For example, JP-11(1999)-260819A shows a method of forming a repairing wire pattern that is produced by process steps of forming an insulator film, coating of positive and negative type photoresist, spot exposure of light and so on. Meanwhile, according to a method shown in JP-2001-264788A, an auxiliary wire is formed along a whole periphery around the array substrate. When disconnection is detected on a wire, opposite ends of the wire are electrically connected with the auxiliary wire by electron beam irradiation. Thus, signal inputting for a wire part further than breakage of the wire is made through the auxiliary wire as making a roundabout along the periphery of the substrate so that signal is transmitted from an edge opposite to input side of the substrate, to the wire part further than the breakage.

The method of JP-11(1999)-260819A requires a series of process steps for forming a film and a patterning, and is thus complicated and unable to sufficiently reduce manufacturing cost. Meanwhile, in the method of JP-2001-264788A, there is a difficulty in selectively inducing electrostatic discharge damage, and thus there is a risk of inducing a new malfunctioning portion. Moreover, not only an area for arranging the auxiliary wire is required but also there arises a problem in that; unless sufficient width is given to the auxiliary wire, retardation or deterioration of the signal occurs so that sufficient restoration of display property is not achieved.

In view of the above, the inventor of present invention has attempted to utilize laser CVD (chemical vapor deposition) technique, which has been recently tried to be used in manufacturing the array substrate as shown in JP-2001-77198A (Japanese Patent Appln. No. 11(1999)-245508) for example.

Not a few disconnections of the wires are accompanied with foreign particles placed on way of the wires. For example, a foreign particle pierced through a laminated layer forms a wire breakage on the wire.

When a repair wire is formed by the CVD technique on such wire breakage having the foreign particle, there arises a risk for forming a disconnection of the repair wire at stepped portion, or for forming other various adverse effects on the repair wire, in accordance with shape or feature of the foreign particle. For this reason, it should be desirable to remove the foreign particle by laser irradiation on beforehand and eventually forming the repair wire by CVD technique.

It was revealed when we actually tried to, however that some sort of the stuck foreign particles were very difficult to be removed. It is particularly difficult for foreign particles of high melting point to be removed without incurring adverse effect on neighboring area. A microscopic spectrometry analysis reveals that; among such particles included are fragments of glass that consist the transparent insulator substrate. If such foreign particles are partly remained as not fully removed, such remained portion of particles may cause disconnection of the wire.

Even when removal is made without fail, if the repair wire is formed by the CVD technique, disconnection is found to occur occasionally. Investigation of the reason of this reveals that a recess formed by removal of the foreign particle is accompanied with inclined face having an overhang or steep gradient that are attributable to the disconnection at stepped portion.

In view of the above drawbacks, it is aimed to facilitate secure repairing a wire breakage on the wire within a pixel area or else, irrespective with type of the wire, and especially irrespective with type, dimensions or shape of the foreign particles causing the wire breakage.

### DISCLOSURE OF THE INVENTION

Invention-wise array substrate for a flat-panel display, typically comprising: a plurality of scanning lines; signal lines arranged substantially perpendicular to the scanning lines with a first insulator film interposed therebetween; switching elements each being disposed in vicinity of respective one of intersections of the scanning lines and the signal lines, and one of terminals of the switching element being electrically connected with the signal line; second insulator film covering a laminated wire pattern including the scanning and signal lines and the switching elements; pixel electrodes being arranged in a matrix each to correspond with respective one of said intersections; pixel electrode contact holes penetrating the second insulator film as to electrically connect the other terminal of the switching element to the pixel electrode; further comprising: a wire breakage portion caused by a foreign matter on the signal line or the scanning line; a pair of contact holes penetrating through the second insulator film as to expose upper face of the signal line or the scanning line at portions opposite with each other in respect of the wire breakage portion; a bypass wire extending from one of said pair of contact holes to another of said pair as to detour the wire breakage portion and as to electrically connect two wire parts pinching the wire breakage portion; a cutout on the pixel electrode being made in an area extending from a vicinity of the wire breakage portion to a place for arranging the bypass wire.

By such feature, breakage of the wire within a pixel area is repaired in a secured way, irrespective with type of the wire breakage, especially irrespective with type, dimensions or shape of the foreign matter that is cause of the wire breakage.

The term “detour” in present invention means taking a route longer than a path on the wire breakage portion in plan view. Thus, excluded is the case taking a vertical roundabout route overlapping the wire breakage portion.

In a preferred embodiment, said bypass wire extends along edges of the cutout of the pixel electrode as to detour a vicinity of the wire breakage portion; and a light insulator film is placed within an area defined by the bypass wire and the wire breakage portion. By this feature, light leakage through the cutout of the pixel electrode is sufficiently prevented especially when the liquid crystal display is of normally white mode.

In an another preferred embodiment, said bypass wire is extended to vicinity of the wire breakage portion as to form a solid pattern covering substantially a whole area inside of the cutout of the pixel electrode. By this feature, not only that light leakage is sufficiently curbed but also wire resistance being lowered.

Invention-wise method for manufacturing an array substrate for a flat-panel display, typically having a plurality of scanning lines; signal lines arranged substantially perpendicular to the scanning lines; pixel electrodes being arranged in a matrix each to correspond with respective one of intersections of the scanning lines and the signal lines; and switching elements each being disposed in vicinity of respective one of said intersections as to input signal from the signal line to the pixel electrode; comprising: a series of film formations and patterning for achieving the signal and scanning lines and the switching elements; subsequently, detecting a wire breakage within a pixel area and position of the wire breakage; forming a cutout on one of the pixel electrodes by removing a conductive film consisting said one of the pixel electrodes at vicinity of the wire breakage, on one side or on opposite sides of a wire having said wire breakage; and forming a bypass wire detouring the wire breakage and electrically connecting two wire parts interlaying the wire breakage.

### BRIEF DESCRIPTION OF THE DRAWING

FIG. 1 is a partial perspective sectional view schematically showing a construction of a repaired portion on an array substrate of the first embodiment;

FIG. 2 is a schematic partial plan view showing a full outline of one pixel dot including the repaired portion, on an array substrate of the first embodiment;

FIG. 3 is a partial sectional view showing multi-layer structure at around TFT, in the array substrate of the first embodiment;

FIG. 4 is partial sectional views schematically showing a process of a applying a laser vaporization technique, in a method of manufacturing an array substrate, of the first embodiment;

FIG. 5 is a schematic partial plan view showing a construction of a repaired portion on an array substrate of the second embodiment; and

FIG. 6 is a schematic partial plan view showing a full outline of one pixel dot including the repaired portion, on an array substrate of the second embodiment;

FIG. 7 is a partial sectional view showing multi-layer structure at around TFT, in the array substrate of the second embodiment;

FIG. 8 is a partial sectional view schematically showing a laser vaporization process, in a method of manufacturing an array substrate, of the third embodiment;

FIG. 9 is a partial perspective sectional view schematically showing a construction of a repaired portion on an array substrate of the third embodiment; and

FIG. 10 is a partial plan view schematically showing peripheral part of the array substrate, including the repaired portion, of the third embodiment.

### BEST MODE FOR CARRYING OUT THE INVENTION

First Embodiment

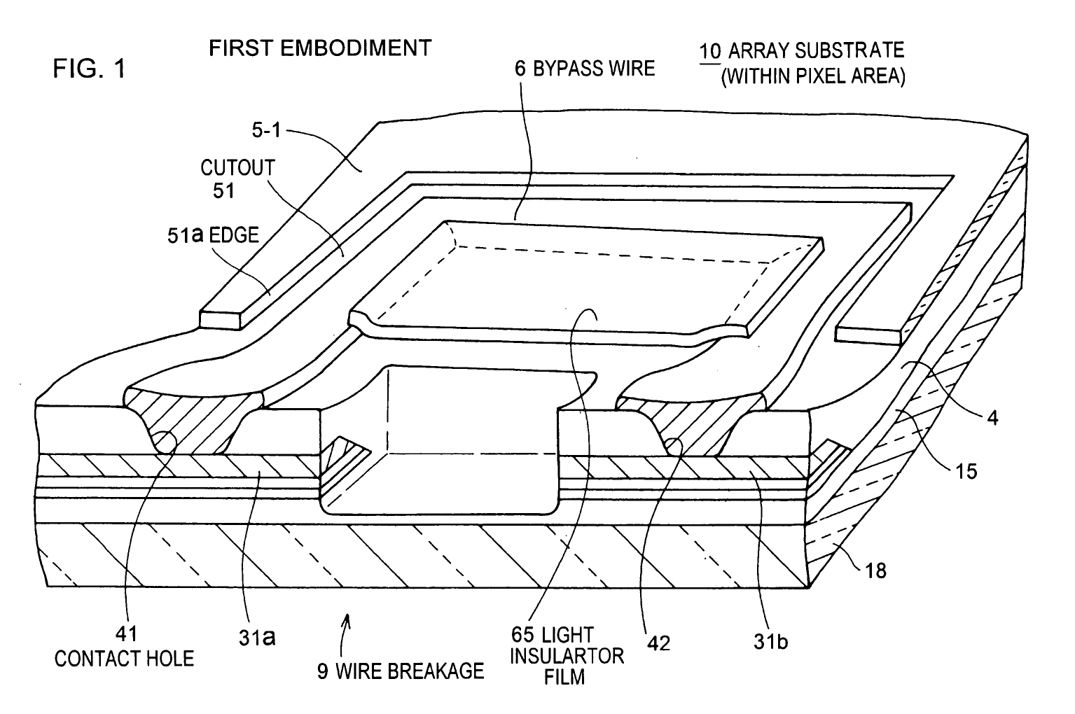

The first embodiment of the present invention will be described with reference to FIGS. 1 through 4. Exemplified in following explanation is a transmission liquid crystal display device of a normally white mode, which has TFTs for respective pixel electrodes as switching elements. Meanwhile, also exemplified in following explanation is a repair for breakage of a signal line due to a foreign matter.

FIG. 1 is a schematic sectional perspective view showing an essential part of an array substrate 10, on which a breakage of a signal line is repaired. In particular, the repairing is made for a wire breakage 9 of a signal line 31 within a pixel area or not in a peripheral area, by forming an angled C-shaped bypass wire 6.

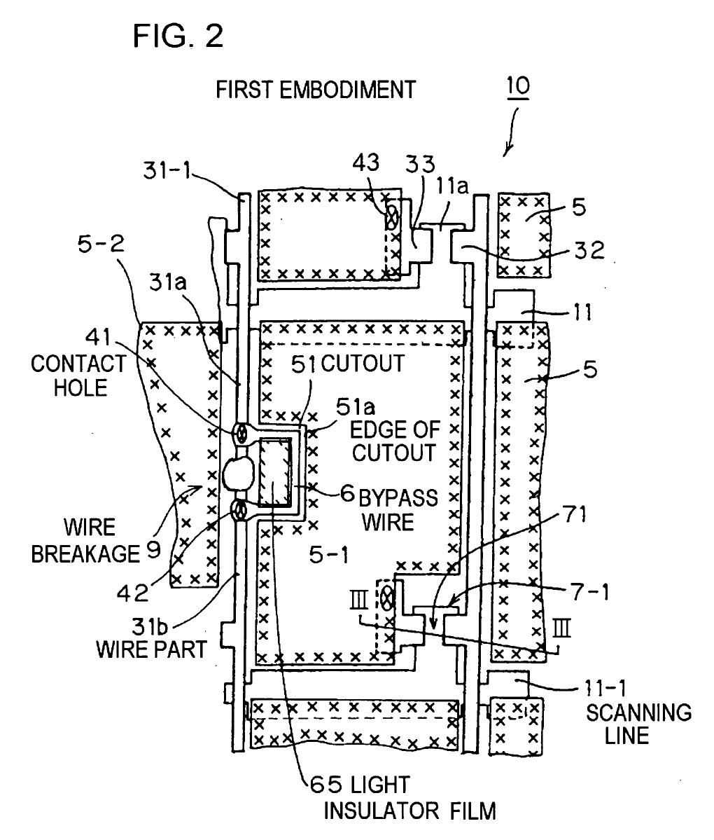

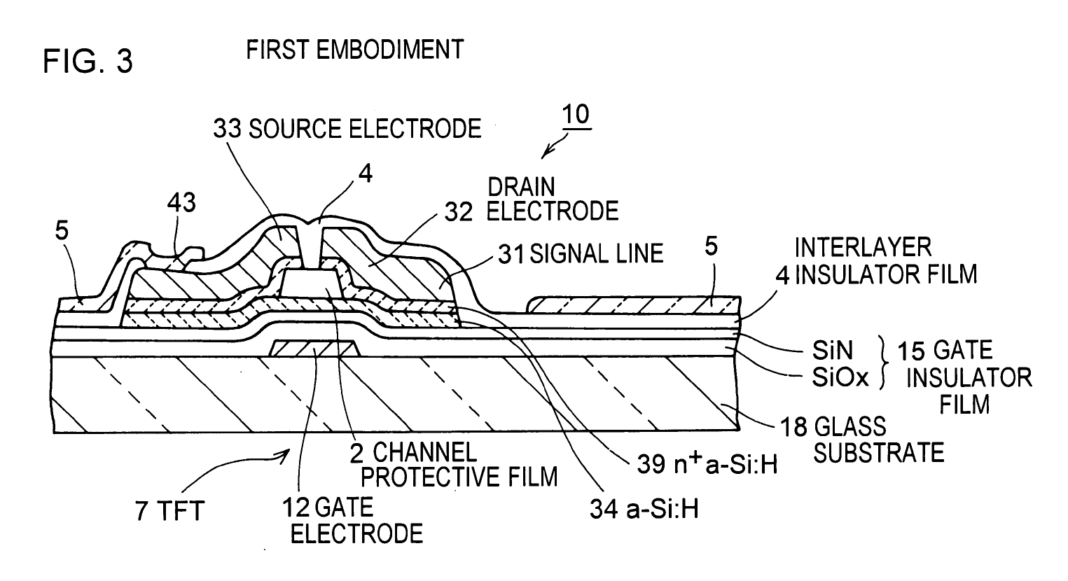

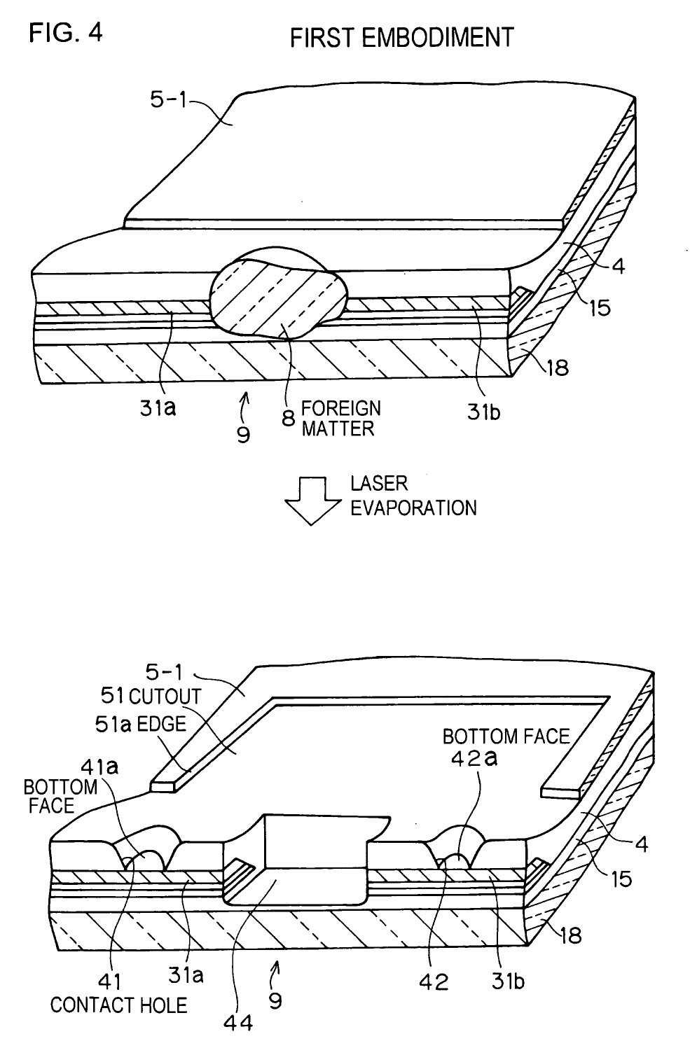

FIG. 2 is a partial plan view showing an entire of a pixel dot on an array substrate. FIG. 3 is a partial sectional view showing a multi-layer structure or laminated structure at around TFT (along a III-III line on the FIG. 2). FIG. 4 shows on its upper part a situation before repairing the wire breakage of a signal line 31 that caused by a foreign matter, and shows on lower part thereof, a situation after applying a laser vaporization technique for the repairing.

The array substrate 10 of the embodiment has a plurality of scanning lines 11 and a plurality of signal lines 31, or drain electrode lines or data lines, on a glass substrate 18. The scanning lines 11 and signal lines 31 are arranged as perpendicular to each other, with a gate insulator film 15 interposed therebetween as shown in FIGS. 2 and 3. Pixel electrodes 5 are arranged in a matrix as each to correspond with a respective intersection of a scanning line 11 and a signal line 11 as to cover substantially entire of one pixel-dot aperture that is defined by the scanning line 11 and the signal line 31. In a vicinity of the each intersection, a TFT 7 is arranged which switches signal inputting from the signal line 31 to the pixel electrode 5 in response of scanning pulse applied to the scanning line 11. Following explanation is given for a case that the TFT is of bottom-gate structure.

The array substrate 10 has a multi-layer arrangement that comprises in a sequence from a bottom: a first conductive layer pattern formed of Molybdenum-tungsten (Mo-W) film, an aluminum (Al) film or the like and comprised of the scanning lines 11 and gate electrodes 11a of the TFTs 9; a gate insulator film 15 formed of silicone oxide and silicone nitride layers; a second conductive layer pattern formed of aluminum (Al) or its alloy or the like and comprised of signal lines 31 and source and drain electrodes of the TFTs 7; an interlayer insulator film 4 formed of silicone oxide layer or the like; and a third conductive pattern layer formed of indium tin oxide (ITO) and comprised of pixel electrodes 5. The each pixel electrode 5 is electrically connected with a source electrode 33 of the TFT 7, through a contact hole 43 perforating the interlayer insulator film 4. According to the above arrangement, the pixel electrodes 5 are disposed at top of the multi-layer structure on the array substrate 10, except for a liquid-crystal alignment layer that is not shown in the drawings.

The TFT 9 in detail is, as shown in FIG. 3, of bottom-gate type having a gate electrode 11a extended from the scanning line 11, and of channel-stopper type having a channel protective film at a place covering channel area of the TFT 7. At such place, a semiconductor active layer 34 formed of amorphous silicone (a-Si:H) is disposed with the gate insulator film 15 therebetween. On the semiconductor active layer 34, a channel protective film 2 is disposed to cover channel area at substantially central part of the TFT 9. At outside of the channel area, the amorphous silicone layer 34 is covered by an ohmic contact layer 39 formed of a phosphorous-doped amorphous silicone layer (n⁺a-Si:H) or the like. At upon the ohmic contact layer 39, a source electrode 33 and a drain electrode 32, which are formed of aluminum, are disposed.

Deposition or coating of films and their patterning for forming the signal lines, scanning lines, TFTs and pixel electrodes etc. on an array substrate may be achieved in an efficient manner with reduced number of process steps; for example in accordance with a method proposed in JP-9(1997)-160076A or JP-2000-267595A, by patterning a conductive layer pattern including the signal lines simultaneously with patterning of a semiconductor layer pattern for the TFTs.

The array substrate 10 of the embodiment has, as shown schematically in FIG. 1, a bypass wire 6 at vicinity of a wire breakage 9 of a signal line 31-1 that is caused by a foreign matter 8, as arranged in a manner as detouring the wire breakage 9. Two ends of the bypass wire 6 are respectively connected with two wire parts 31a and 31b of the signal line 31-1 being separated with each other by the foreign matter 8; through respective contact holes 41, 42 perforating the interlayer insulator film 4. In an example shown in the drawings, width dimension of the bypass wire 6 is substantially constant except for the two ends part of larger width, which covers the contact holes 33.

When forming the bypass wire 6, as to curb electrical conduction or leakage to the pixel electrode 5, ITO film consisting the pixel electrode 5 is removed on beforehand in an area ranging from the wire breakage 9 to a place accommodating the bypass wire 6. In respect of thus formed cutout 51 of the pixel electrode 5, an area encircled by the wire breakage 9 and the bypass wire 6 is almost entirely covered with a light insulator film 65 formed of metal, in order for curbing leakage of backlight illumination at the cutout 51. Particularly in an example shown in the figure, the light insulator film 65 overlaps inner fringe of the bypass wire 6, as to minimize the leakage of the illumination.

Outline of process for producing such a repaired portion will be explained by use of FIGS. 1, 2 and 4.

If inspection procedure for the array substrate 10 reveals that a wire breakage 9 is formed on a signal line 31-1, position of the wire breakage 9 is accurately determined, for example by use of an X-Y movable table and a microscope device. In same time, it is determined whether the wire breakage 9 is caused by a foreign matter 8 or not.

If the wire breakage 8 is caused by a foreign matter 8, rough dimensions of the foreign matter 8 are determined and then, following process steps (1)-(4) are conducted.

(1) Forming a Cutout 51 on the Pixel Electrode (FIG. 4)

Firstly, a cutout 51 is formed on a pixel electrode 51-1 that is one among two pixel electrodes 51-1, 51-2 neighboring the wire breakage 9. An area in vicinity of the wire breakage 9 is irradiated with laser beams so that within such area, the ITO film consisting the pixel electrode 5 is removed. In other words, laser evaporation technique or zapping technique is applied to remove the ITO film of the pixel electrode 5 on an area in vicinity of the wire breakage 9.

Then, the foreign matter 8 is removed by laser irradiation of same manner. In an example shown in the figure, a substantially rectangular recess 44 with a flat bottom is formed at a place where the foreign matter 8 is removed. In particular, such removing is made to an upper portion of the gate insulator film 15 as to surely eliminate the foreign matter 8.

(2) Forming of Contact Holes 41, 42 and Removing of the Foreign Matter (FIG. 4)

Then, on opposite side of the wire breakage 9, there are formed contact holes 41, 42 for exposing upper face of the wire parts 31a and 31b of the signal line 31-1. These contact holes 41, 42 are formed by use of the laser evaporation technique or zapping technique in a same manner—places that are distanced from the wire breakage 9 by a certain distance are irradiated with laser beams as to remove the interlayer insulator film 4 on such places.

(3) Forming of the Bypass Wire 6 of Angled-C Shape

Subsequently, laser CVD (chemical vapor deposition) technique is applied for locally depositing of metal layer so as to form a bypass wire 6 that extends, from one to another of the contact holes 41, 42, along an edge 51a of the cutout 51 on the pixel electrode 5. The bypass wire 6 also covers bottom faces of the contact holes 41, 42 (see FIG. 4) and directly contact with the wire parts 31a, 31b on opposite sides, as to be electrically connected respectively with them. In this occasion, thickness of the metal layer formed by the laser CVD technique, which is thickness of the bypass wire 6, is made as larger than or almost same with the interlayer insulator film 4. In a concrete example, thickness of the bypass wire 6 is 300 nm and thickness of the interlayer insulator film 4 is 230 nm. Consequently, discontinuity or so called “stepped-portion disconnection” is not formed on a metal layer of the bypass wire, at fringe of the contact holes 41, 42.

The bypass wire 6 is distanced from the edge 51a of the cutout on the pixel electrode 5, by a distant necessary for sufficient curbing of the leak electricity. In same time, the distance is set to be minimum necessary for curbing of the leak electricity, so as to sufficiently curbing leakage of the backlight illumination. In the example, the distance is set to be 5 μm. Then, through thus formed bypass wire 6 formed of metal layer, two wire parts 31a and 31b separated by the wire breakage 9 are electrically connected with each other.

(4) Forming of the Light Insulator Film 65

A pattern of light insulator film 65 is formed by the laser CVD technique so that an area encircled by the bypass wire 6 and the two wire parts 31a and 31b is entirely or almost entirely coated with the film. Whereas the light insulator film 65 hereto explained as an island pattern that is not joined up with the bypass wire 6, the light insulator film 65 may be formed integrally with the bypass wire 6 as will be explained later.

By disposing such a light insulator film 65, light leakage at inside of the bypass wire 6 is curbed. Moreover, minimizing of the gap between the bypass wire 6 and the edge 51a of the cutout 51 on the pixel electrode 5 enables suppression of light leakage at such gap to a level of possible minimum, at which substantially no problem is arisen in practical use.

In following, a concrete example for conditions of the laser CVD and laser irradiation will be given.

For depositing a conductive layer by the laser CVD technique, adopted light source of the laser beams is Nd⁺³:YLF and its third harmonic wave at 349 nm is used.

When forming the bypass wire 6, so as to locally deposit tungsten (W) metal, a tungsten-containing carbonyl compounds such as W(CO)₆ is adopted as a source gas while argon (Ar) gas is used as carrier gas. For example, adopted laser beams is of continuous oscillation at energy level of more than 100 mW (4 kHz); and by this way, a wire metal in 5 μm width and 0.3 μm thickness is formed.

Using of the tungsten-containing carbonyl compounds as in above concrete example is preferred, because achieved are high efficiency of decomposition and deposition under laser beams as well as excellent stability in film formation. Nevertheless, other source gas such as chrome carbonyl or the like may be used in some occasions. Thus, the bypass wire 6 may be formed by chrome or the other metal. Meanwhile, for a carrier gas, argon gas is preferred while nitrogen gas or the like may also be used.

Width of the bypass wire 6 may be set in accordance with situation or requirement by adjusting energy level or slit width of the laser beams, for example as selected from a range of 2-25 μm. Thickness of the bypass wire 6 may also be set in accordance with situation or requirement, for example as from a range of 2-25 μm.

Meanwhile, when to form the cutout 51 by removing the ITO film consisting the pixel electrode 5, following laser beams are adopted for example; laser beams are originated from a laser device as in above and being modulated with a ultrasonic Q-switching device; and energy level of the laser beams are in a range of 0.4-0.6 mJ (1-10 Hz). When to remove the insulator film 4 for forming the contact holes 41 and 42, laser beams in same as above are used except that energy level exceeds 0.6 mJ (2 Hz).

By hereto explained way, a single and same laser device is utilized for formation of the bypass wire 6 with the laser CVD as well as for formation of the cutout 51 and contact holes 41, 42, as to achieve efficient operation.

When to form the bypass wire 6 by use of laser CVD, it is preferable to adopt a laser beams in ultraviolet range such as third harmonic wave of the YLF laser, if the pixel electrodes are transparent ones formed of ITO etc. If the pixel electrodes are reflective electrodes formed of films of metal such as aluminum or its alloy, second harmonic wave of the YLF laser may be used. As a source of the laser beams, it is preferable to adopt the YLF laser as in the above concrete example or adopt YAG laser because the above of energy level is easily achieved. Carbon dioxide laser or other laser may also be used depending on occasions.

In explanation of the above embodiment, the bypass wire 6 is shaped as an angled “C” detouring the wire breakage. Nevertheless, the bypass wire may be shaped as a smooth-curved “C” character, or in otherwise shaped as an “L” having only one flection. The bypass wire is formed as above in a two-dimensional position not over lapping a line along the signal line so that wire breakage of the bypass wire is curbed.

Second Embodiment

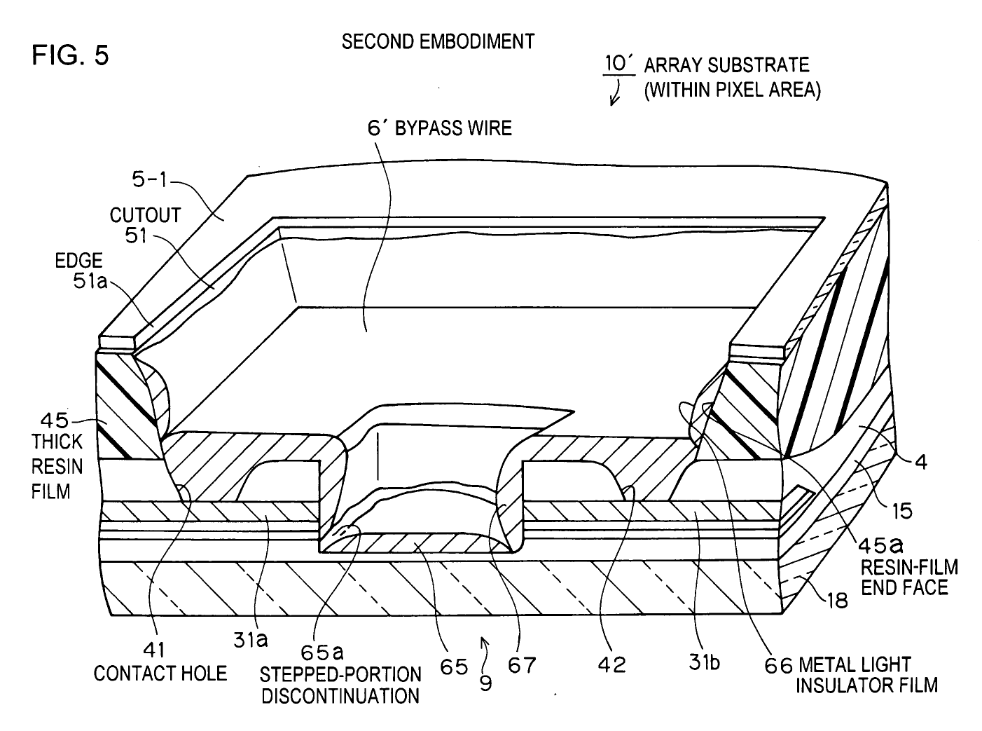

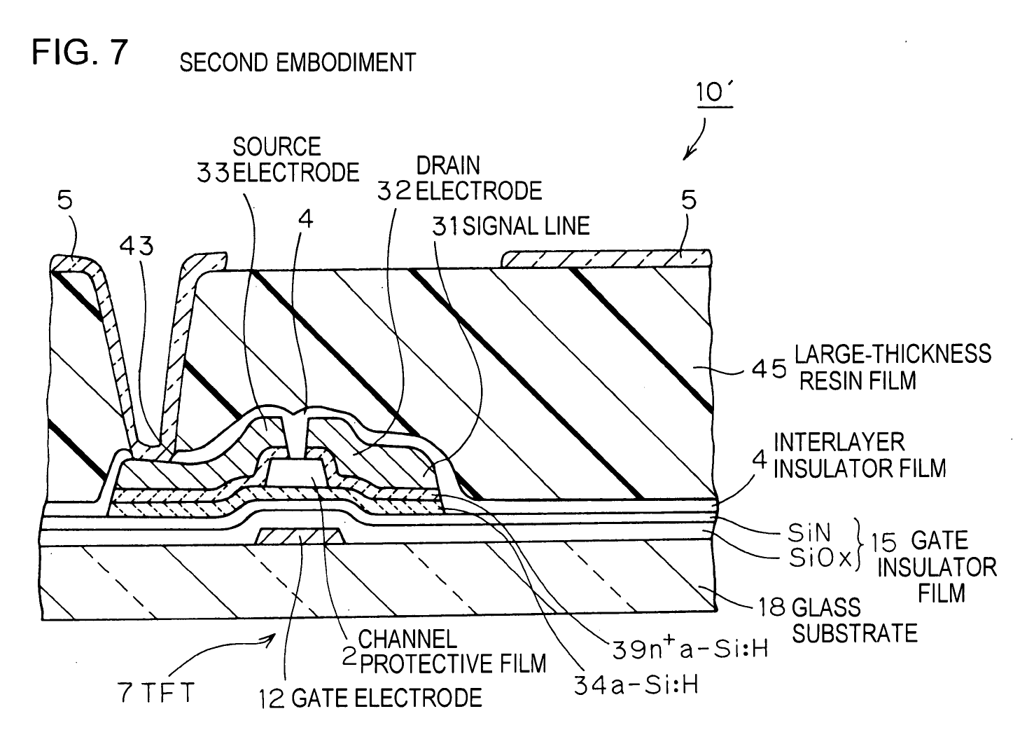

The array substrate and its manufacturing method of the second embodiment will be explained by using FIGS. 5-8. The array substrate of this embodiment is one for transmissive liquid crystal display of normally white mode having TFTs as switching elements for respective pixel electrodes. The array substrate of this embodiment is same as the first embodiment except for having an insulative large-thickness resin film 45 as interposed between a pattern of pixel electrodes and a pattern of TFT and other wire layers, within a pixel area (FIG. 7). The large-thickness resin film 45 has a thickness of 1-10 μm in general and of 2-4 μm typically and is formed of organic resin having low dielectric constant. The resin film 45 enables sufficient suppressing of electric capacitance formation and of short-circuiting, between the pixel electrodes and signal lines that are superimposed with each other as interposing the resin film 45. The large-thickness resin film 45 in an example shown in FIG. 7 is overlaid on an interlayer insulator film 4, whereas the resin film 45 may be disposed in place of the interlayer insulator film 4.

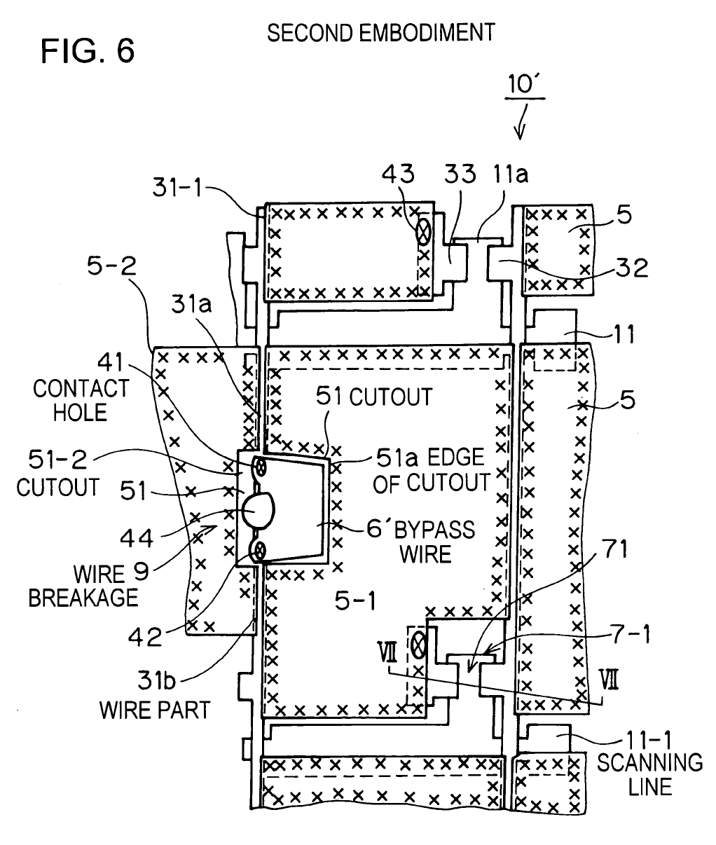

FIG. 5 is a schematic sectional perspective view showing an essential part of the array substrate 10′ in which a wire breakage on a signal line is repaired. FIG. 6 is a schematic plan view showing a construction of the pixel dots at and around the repaired portion. Construction of the array substrate 10′ of this embodiment is same with that of the first embodiment except for minor difference of the repaired portion and for existence of the large-thickness resin film 45.

In the repaired portion, as shown in the FIGS. 5-6, a kind of bypass wire 6′ is disposed as detouring the wire breakage 9 of the signal line 31, as to electrically connects the two wire parts 31a and 31b of the signal line. In a concrete example shown in the drawings, a rectangular recess 44 as in the first embodiment is formed at the wire breakage by the repairing.

The bypass wire 6′ of this embodiment is, however, formed as a rectangular solid pattern instead of the angled C shape. In other words, the bypass wire 6′ is shaped in a manner that the angled-C shaped bypass wire 6 of the first embodiment is inwardly extended to fringe of the recess 44 at the wire breakage 9, so that a part corresponding to the light insulator film 65 is integrally formed with the bypass wire.

As shown in the FIG. 5, the bypass wire 6′ of this embodiment is disposed within a resin-film cutout area 46 in a substantially rectangular shape in which interlayer insulator film 4 is exposed by being removed with the large-thickness resin film 45. A fringe of the resin-film cutout area 46, which is an upper edges of the end faces 45a of the large-thickness resin film 45, coincides substantially with a fringe of the cutout 51 on the pixel electrode 5. The end faces 45a of the large-thickness resin film 45 are coated with a metal insulator film 66 extended from brim of the bypass wire 6′. In an example shown in the FIG. 6, the cutout 51 of the pixel electrode 5 is also formed at a side opposite to the bypass wire 6′, in view from the wire breakage 9, so as to curb short circuiting between the neighboring pixel electrode 5-2 and the bypass wire 6′.

In following, processes for manufacturing the repaired portion are explained, so as to further detail this embodiment.

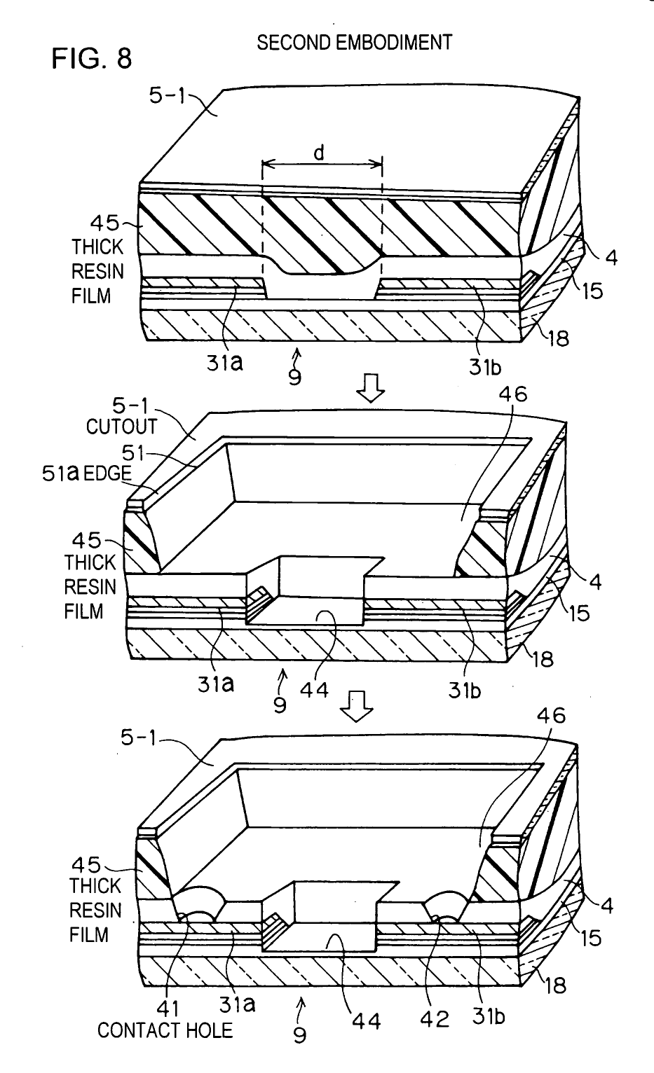

When the array substrate is completed, for example by a method shown in JP-2000-29055A (U.S. application Ser. No. 09/349245), the array substrate is subjected to inspection process. If the inspection process reveals a wire breakage formed on a signal line 31-1, determined are position of the wire breakage 9 as well as a dimension of the wire breakage 9, which is distance d between the two wire parts 31a and 31b (upper part of the FIG. 8).

(1) Formation of the Edgewise Cutout 51 on the Pixel Electrode and the Cutout 46 on a Large-thickness Resin Film 45 (Center Part of FIG. 8)

By a laser evaporation technique same as explained for the first embodiment, the pixel electrode 5 and the large-thickness resin film 45 are removed as to expose the interlayer insulator 4, in vicinity of the wire breakage 9. Consequently, an edgewise cutout 51 of the pixel electrode 5-1 as well as the resin film cutout 46 are formed on a side of one among two pixel electrodes 5-1 and 5-2 sandwiching the wire breakage 9.

In this occasion, at an example shown in FIG. 6, a cutout 51-2 is also formed on another pixel electrodes 5-2 among the two pixel electrodes 5-1 and 5-2 sandwiching the wire breakage 9. However, indent-wise dimension of this cutout 5-2 is considerably smaller than that disposed together with the resin film cutout 46. The indent-wise dimension is set as only sufficient to separate the pixel electrode 5-2 from a region of the contact holes 41 and 42 and wire breakage 9 as to curb short-circuiting with metal film on the region.

(2) Removing at the Wire Breakage (Center Part of the FIG. 8)

At the place of the wire breakage 9, the laser evaporation technique in same manner as above is applied as to make a recess 44 reaching the gate insulator film 15. The dimension of the recess 44 on an example shown in the drawing agrees substantially with the distance “d” between the wire parts 31a and 31b.

(3) Formation of the Contact Holes 41, 42 (Bottom of the FIG. 8)

The laser evaporation technique as above is further applied to make the contact holes 41 and 42 as in preceding embodiment, at places interposing the wire breakage 9. In other words, upper surfaces of the wire parts 31a and 31b, which are separated by the wire breakage 9, are respectively exposed.

In an example shown in the drawings, no foreign matter 8 has been existed; nevertheless, the recess 44 is formed without detecting existence of foreign matter; in this way, the detection process is omitted or simplified and the repair is made by a constant procedure.

In otherwise, the recess may be formed, after removing of the large-thickness resin film 4, if and only if the foreign matter is found to be remained. When not forming the recess 44, a CVD wire for repairing is formed as to cover a region including the wire breakage 9. In order for achieving a reliable repairing, the laser CVD technique is used to form a “bypass wire” part detouring the wire breakage 9 as well as a pattern in a rectangular or other shape covering the wire breakage. Thus, a kind of bypass wire is also formed even in this manner of repairing.

(4) Formation of the Bypass Wire 6′ in a Solid Rectangular Shape (FIGS. 5-6)

The laser CVD technique as explained in the first embodiment is used to deposit a metal layer substantially covering entire of the resin-film cutout 46. Consequently, the bypass wire 6′, which is formed on the interlayer insulator film 4 within the resin-film cutout 46, forms a single solid pattern in a substantially rectangular shape. Meanwhile, the metal light insulator 66 covering the end faces 45a of the large-thickness resin film 45 is formed as continuous with brim of the bypass wire 6′, so as to curb leakage of light through the end faces 45a. Thickness of the large-thickness resin film 45 reaches 4-5 μm for example, thus it is required to curb the light leakage through the end faces 45a, in many cases.

In an example shown in the drawings, prior attention is made on the curbing of the light leakage, and thus the metal light-insulator film 66 reaches vicinity of upper edges of the end faces 45a of the resin film. When the prior attention is made on curbing short-circuiting with the pixel electrode 5-1 in otherwise, the metal light-insulator film 66 may be omitted on uppermost part near the edge of the end faces 45a.

In an example shown in the drawings, metal layers 65, 67 are formed on bottom and wall faces of the recess 44 that is formed on the wire breakage 9, simultaneously with the bypass wire. As shown in the FIG. 5, a discontinuation 65a due to stepped portion is formed between the metal layer 65 on the bottom face of the recess 44 and the metal layer 67 on the wall face of the recess 44. Thus, even when the metal layer 67 on the wall face is electrically connected with the bypass wire 6′, the metal layer 65 on the bottom face is electrically disconnected at all, or only partly connected, to the metal layer 67 on the wall face of the recess 44. Consequently, the electrical conduction between the two wire parts 31a and 31b separated by the wire breakage 9 is made through the bypass wire 6′ substantially in a solid rectangular shape that extends to detour the recess 44 on the wire breakage 9.

In following reasons, the large-thickness resin film 45 is removed on beforehand at a place for disposing the bypass wire 6′ in this embodiment.

(i) Curbing of Wire Breakage or the Like Due to Crack of the Resin Film

The large-thickness resin film 45 is in general formed of a material such as acryl resin or its analogous; thus, a crack may occur on the resin film when subjected to high temperature at laser CVD process. Thus, when the bypass wire 6′ is formed directly on the resin film 45, a wire breakage may be formed on the bypass wire 6′ due to a crack on its bottom layer.

(ii) Curbing of Wire Breakage on Brim of the Contact Holes 41, 42

When the contact holes 41, 42 are perforating the large-thickness resin film 45 as well as the interlayer insulator film, discontinuation of the conductive layer due to stepped portion may occur, unless wall faces of the contact holes are in a considerably small inclination. Nevertheless, because such contact holes are formed by laser irradiation, such a small inclination is hard to be achieved.

Therefore, a reliable repairing is achieved when the large-thickness resin layer 45 is removed on beforehand.

In a concrete example of the dimension-wise construction, the bypass wire 6′ other than portions for covering the contact holes 41 and 42 is a solid rectangular pattern of 20 μm (direction along the signal line 31)×10 μm (direction perpendicular to the signal line 31).

According to hereto explained embodiments, repairing of wire breakage on a signal line does not require patterning processes of film formation, light exposure and the like; nor require preparation of backup wire. Moreover, even when dealing with a wire breakage caused by a foreign matter, removing it is not necessarily required. Thus, no defect or malfunction would be newly developed and no adverse effect such as increasing of the width of non-displaying peripheral area or decreasing of pixel-dot aperture ratio.

Particularly when the wire breakage is caused by a foreign matter, reliable repairing irrespective of nature, aspect and dimensions of the foreign matter is achieved by a simple and low-cost process; without causing a discontinuation of the wire for repairing due to stepped portion.

By the above embodiments, it is assured that from a defective array substrate found to have a wire breakage defect, an array substrate that works fairly normally is obtainable. Thus, yield ratio or percentage of non-defective product of the array substrate is increased. Moreover, the repairing is achieved by nearly minimum burden or cost of process and equipment; thus, production efficiency of the array substrate is increased, and the entire cost for producing the array substrate is decreased. On top of these, burden in process and cost for scrapping the defective array substrate is reduced.

In the above embodiments, explanation is made only for a case that wire breakage is caused by a foreign matter and a case that repairing is made without determining whether the wire breakage is due to the foreign matter or not. Nevertheless, if the wire breakage is determined to be not due to the foreign matter, repairing may be achieved by following: forming a wire for repairing as extending along and overlapping the signal line by use of the CVD technique as in above; without forming a cutout on the pixel electrode.

Meanwhile, even when the wire breakage is determined to be not due to the foreign matter, a repairing may be made by the bypass wire detouring the wire breakage in a same manner as above. Though such repairing will make somewhat the repairing process to be complicated, the possibility of causing defects such as discontinuation of a wire due to a stepped portion is decreased so that repairing of a line defect is achieved in a more reliable manner.

In the above embodiments, a length of the bypass wire 6 is remarkably shorter than that of the signal line 31 and thickness and width of the bypass wire are set to sufficient extent; thus, causing substantially no increase of the electrical resistance of the signal line 31. Therefore, even when drive frequency becomes high, defects or malfunction such as insufficient writing on the pixels is curbed.

Especially, the wire resistance become fairly small when the bypass wire is formed as a solid pattern of rectangular shape or the like as in the second embodiment, in which a bypass wire and a metal light insulator film at inside of the bypass wire are integrally formed. In some situations, the bypass wires may be disposed on opposite sides of the wire breakage as to form two bypass wires to a single wire breakage.

In the first embodiment, the cutout 51 on the pixel electrode is formed in a rectangular shape and the bypass wire 6 is accordingly formed in an angled-C shape; thus, alignment of laser irradiation spot is easily made. Moreover, because the inside of the bypass wire 6 is resultantly shaped as rectangular, forming of the light insulator film in a rectangular shape should be enough as to simplify a procedure for forming the light insulator film.

Also in the second embodiment, the indent-wise cutout 51 of the pixel electrode and resin film cutout 46 are formed as rectangular; thus, when to form the bypass wire 6′ in a solid rectangular shape, it is enough to move the laser irradiation spot along the signal line in a scanning manner as to simplify procedures for alignment and moving of the irradiation spot.

In the above embodiments, explanations are made for repairing of a wire breakage on the signal lines, while repairing of a wire breakage on the scanning lines may be made in a same manner. The repairing is in same manner even when TFTs are of top gate type.

In the above embodiments, the foreign matter 8 is removed and the recess 44 is formed in view of possibility of that the foreign matter is detached at after processes to cause adverse effect. When such possibility does not exist, it goes without saying that forming of the recess 44 on the wire breakage 9 is not necessary.

In the above embodiments, explanations are made as the signal lines are covered with the interlayer insulator film, while the signal lines and the pixel electrodes may be disposed on a same insulator film. In such case, it is not necessary to form contact holes exposing the signal line on two places sandwiching the wire breakage. Meanwhile, in following case, the bypass wire may be disposed to connect two separated parts of a redundancy wire; the redundancy wire formed of ITO film is superimposed on a signal line through an interlayer insulator film therebetween; and the wire breakage due to the foreign matter is formed also to the redundancy wire.

When the wire breakage of a signal or scanning line is formed in vicinity of a crossing of a signal line and a scanning line, repairing may be made by following; cutouts 51 are formed on corners of two adjacent pixel electrodes, and the bypass wire 6 is disposed to run across the scanning line 11. If the wire breakage is also formed on the scanning line 11, a repairing portion such as bypass wire 6 for repairing such wire breakage may also be formed.

Third Embodiment

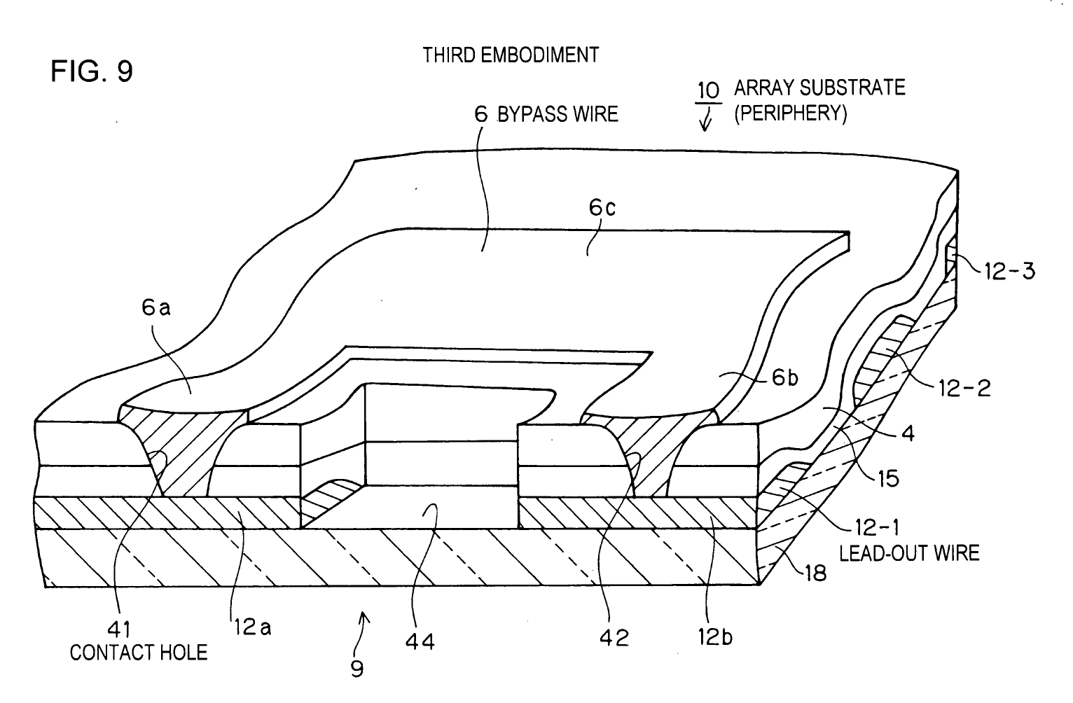

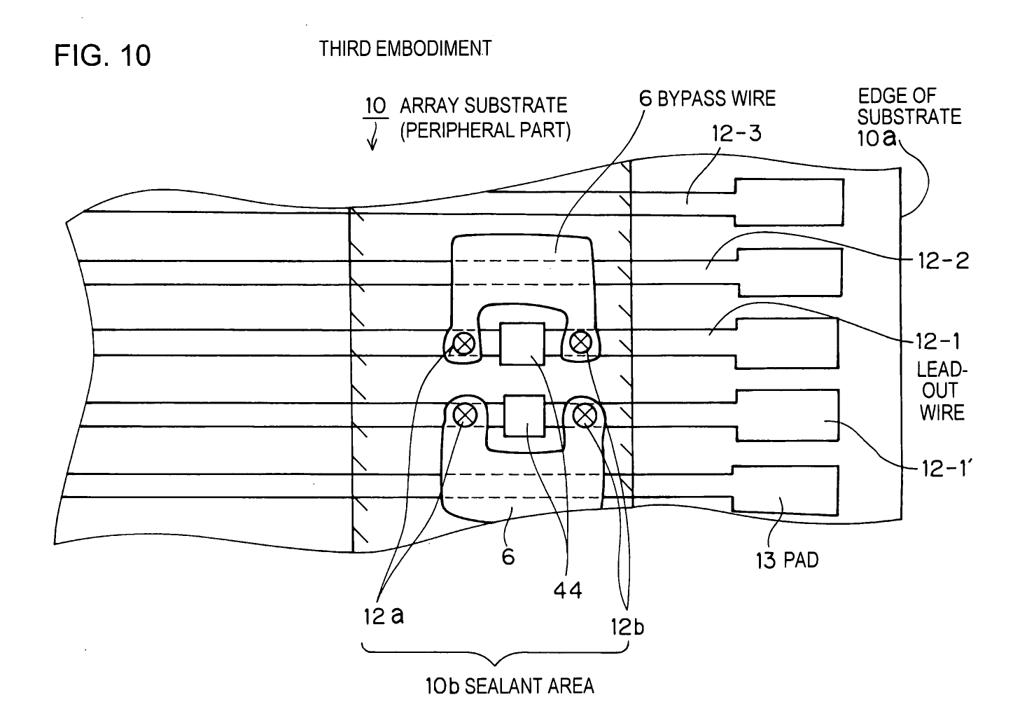

In following, the array substrate and its manufacturing method are explained by use of FIGS. 9-10.

FIG. 9 is a schematic sectional perspective view showing essential part of the array substrate having a wire breakage on a lead-out wire 12-1, or a wire lead out from the pixel area. FIG. 10 is a partial plan view showing a construction of a peripheral part of the array substrate 10 including a repaired portion. In the array substrate 10 of this embodiment, a wire breakage of the lead-out wire 12 on peripheral part is repaired instead of the signal line in the pixel area. The lead-out wire is a wire lead out from a signal or scanning line in the pixel area to vicinity of an edge 10a of the substrate, see FIG. 10. At outer ends of the lead-out wires 12, pads 13 for connecting with outside and for inspection are arranged.

In an example shown in the drawings, a recess 44 for exposing glass substrate 18 is formed at a wire breakage 9 by a laser irradiation in same manner as foregoing embodiments. Procedures same as foregoing embodiments are taken to form contact holes 41 and 42 for exposing upper surfaces of the two wire parts 12a and 12b sandwiching the wire breakage 9, and to form a bypass wire 6. The bypass wire 6 of this example is shaped as a solid rectangular pattern having an edge-wise cutout or as an angled C shape detouring around of the wire breakage 9. Width of the bypass wire 6 is at least about 2-3 times of width of the lead-out wires 12. In detail, the width of the bypass wire 6 at a portion covering the contact holes 41 and 42 as well as at portions 6a and 6b extending perpendicular to the lead-out wire 12 are about 2-3 times of width of the lead-out wires 12. The width of the bypass wire 6 at a part 6c of the solid rectangular pattern extending along the lead-out wire 12 is about 2-4 times of the width of the lead-out wires 12.

In a concrete example shown in FIGS. 9-10, the part 6c of the solid rectangular pattern reaches a region between a next lead-out wire 12-2 and a further successive lead-out wire 12-3. In a concrete example shown in FIG. 10, a repairing is made as a same place to two lead-out wires 12-1 and 12-2 adjacent with each other. Thus, the two bypass wires 6 are formed as opposite to each other. In the example shown in the drawings, the bypass wire 6 is positioned within an area 10b for disposing sealant material, thus, no bypass wire is exposed to outside.

By such construction of the repaired portion, repairing of the wire breakage is made in a reliable manner with substantially minimum burden of the processes and the equipments, as in the foregoing first and second embodiments. The removing of the foreign matter causing the wire breakage is not necessary, also in this embodiment.

At these embodiments, explanations are made on an array substrate of amorphous silicone (a-Si) TFT type, while same goes for an array substrate the poly-crystalline silicone (p-Si) TFT type. In case of latter, repairing as above is applied to the array substrate manufactured by a method shown in JP-2000-330484A or JP-2001-339070A for example.

### INDUSTRIAL APPLICABILITY

For a wire breakage occurred in a wire within the pixel area, a reliable repairing is achieved irrespective to nature of the wire breakage, especially irrespective to nature, dimensions and shape of the foreign matter causing the wire breakage.

What is claimed is:

1. An array substrate comprising:
a first wire line arranged on a substrate;
a second wire line run as extended from the first line but not continuous with the first wire line, and being arranged in a wire pattern layer same with the first wire lines; and
a conductor connecting the first and second wire lines and being arranged to cover the first and second wire lines through an insulator film;
said insulator film having a first aperture exposing a portion of the first wire line and having a second aperture exposing a portion of the second wire line;
said conductor being connected with the first and second wire lines respectively through the first and second apertures; and
length of said connector wire being larger than length directly connecting the first and second apertures in a direction along the first and second wire lines, in a plan view.

2. An array substrate for a flat-panel display comprising:
a plurality of scanning lines;
a plurality of signal lines arranged substantially perpendicular to the scanning lines through a first insulator film therebetween;
switching elements respectively disposed in a vicinity of each intersection of the scanning and signal lines, and a terminal of the switching element being electrically connected with the signal line;
a second insulator film covering such multi layer wiring pattern;
pixel electrodes arranged in a matrix as to respectively correspond to said each intersection, on the second insulator film;
pixel-electrode contact holes perforating the second insulator film as to electrically connect another terminal of the switching element to the pixel electrode;
wire breakage occurred to the signal or scanning line;
a pair of contact holes perforating the second insulator film as to expose upper face of said signal or scanning line, at its wire portions interlaying the wire breakage;
a bypass wire extending from one to another of the pair of contact holes as to detour the wire breakage and to electrically connect said wire portions interlaying the wire breakage;
a pixel-electrode cutout being formed by removing the pixel electrode in an area ranging from vicinity of the wire breakage to a place receiving the bypass wire line.

3. An array substrate according to claim 2,
said bypass wire running along edge of the pixel-electrode cutout as to detour vicinity of the wire breakage; and
further comprising a light-insulator film arranged on an area surrounded by the wire breakage, the bypass wire and said wire portions interlaying the wire breakage.

4. An array substrate according to claim 2 or 3,
said bypass wire being spaced apart from the pixel electrode as to prevent electrical contact between them.

5. An array substrate according to claim 2, said bypass wire being a solid pattern as extended to vicinity of the wire breakage so as to cover substantially whole area within the pixel-electrode cutout.

6. An array substrate according to claim 2 or 5,
the second insulator film being a resin film having thickness equal to or more than 1 μm or being a multi-layer film including such resin film;
the bypass wire being arranged in an area removed with the resin film and exposed with a non-resin insulator film.

7. A method for manufacturing an array substrate for a flat-panel display having a plurality of scanning lines; signal lines arranged substantially perpendicular to the scanning lines; pixel electrodes being arranged in a matrix each to correspond with respective one of intersections of the scanning lines and the signal lines; and switching elements each being disposed in vicinity of respective one of said intersections as to input signal from the signal line to the pixel electrode; comprising:
a series of film formations and patterning for achieving the signal and scanning lines and the switching elements;
detecting a wire breakage on a wire within a pixel area and position of the wire breakage;
forming a cutout on one of the pixel electrodes by removing a conductive film consisting said one of the pixel electrodes at vicinity of the wire breakage, on one or both of areas demarcated by said wire having the wire breakage, by laser irradiation; and
forming a bypass wire detouring the wire breakage and electrically connecting two wire parts interlaying the wire breakage, by sequential or continuous depositing of a conductive layer at inside of said cutout using laser CVD technique.

8. A method for manufacturing an array substrate for a flat-panel display comprising:
a series of film formations and patterning for forming a plurality of scanning lines; signal lines arranged substantially perpendicular to the scanning lines with a first insulator film therebetween; and switching elements each being disposed in vicinity of respective one of intersections of the scanning lines and the signal lines and having a terminal electrically connected with the signal line; and thereby forming a multi-layer wire pattern including the scanning and signal lines and the switching elements;
forming a second insulator film covering the multi-layer wire pattern;
forming pixel electrodes being arranged in a matrix each to correspond with respective one of said intersections, on the second insulator film;
forming pixel-electrode contact holes for perforating the second insulator film as to connect another terminal of the switching element to the pixel electrode; further comprising:
detecting a wire breakage on a wire within a pixel area and position of the wire breakage;
forming a cutout on one of the pixel electrodes by removing a conductive film consisting said one of the pixel electrodes at vicinity of the wire breakage, on one or both of areas demarcated by said wire having the wire breakage, by wire breakage; and
forming a bypass wire detouring the wire breakage and electrically connecting two wire parts interlaying the wire breakage, by sequential or continuous depositing of a conductive layer at inside of said cutout using laser CVD technique.

9. A method for manufacturing an array substrate according to the claim 7 or 8,
the bypass being formed as running along edge of said cutout of the pixel electrode and as detouring vicinity of the wire breakage at said forming of the bypass; and further comprising:
depositing a conductive layer by laser CVD technique to an area surrounded by the bypass wire, the wire breakage and wire portions interlaying the wire breakage, as to form a pattern of a light insulator film covering said area, after the forming of the bypass wire.

10. A method for manufacturing an array substrate according to the claim 7 or 8, wherein
a resin film having a thickness equal to or more than 1 μm or a multi-layer film including the resin film is formed as the second insulator film;
a laser irradiation is used for forming the cutout of the pixel electrode and for exposing the removing the resin film within a region inside of the cutout as to expose an insulator film thereunder.

11. A method for manufacturing an array substrate according to the claim 7, 8 or 10, the bypass wire being formed as a solid pattern filling inside of said cutout.

12. A method for manufacturing an array substrate according to the claim 7, 8 or 10, a laser CVD technique being used to form the bypass wire and to form a metal light-insulator film covering an end face of the resin film.

13. A method for manufacturing an array substrate according to the claim 7 or 8, wherein when the wire breakage is determined to be due to interposing of a foreign matter, then said forming of the cutout and said forming of the bypass wire is made; and when the wire breakage is determined to be due to other cause, then a connecting wire extending along said wire is formed by CVD technique.

14. An array substrate for a flat-panel display comprising a plurality of scanning lines; signal lines arranged substantially perpendicular to the scanning lines with a first insulator film therebetween; switching elements each being disposed in vicinity of respective one of intersections of the scanning lines and the signal lines and having a terminal electrically connected with the signal line; a second insulator film covering a multi-layer wire pattern comprised of the signal and scanning lines and the switching elements; pixel electrodes being arranged in a matrix each to correspond with respective one of said intersections; pixel-electrode contact holes for perforating the second insulator film as to connect another terminal of the switching element with the pixel electrode; and lead-out wires leading out from the scanning lines and the signal lines to peripheral part outside of a pixel area; further comprising:
a wire breakage formed on the lead-out wire due to interposing of a foreign matter;
a pair of contact holes perforating the second insulator film as to expose upper surface of the lead-out wire at its portions interlaying the wire breakage; and
a bypass wire extending from one to other of the pair of contact holes and detouring the wire breakage, on the second insulator film, as to electrically connect two wire parts interlaying the wire breakage; and
said bypass wire having a width more than two times of that of the lead-out wire.

15. A method for manufacturing an array substrate for a flat-panel display comprising:
forming a plurality of wires on a substrate;
forming an insulator film coating the wires;
detecting a wire breakage among the plurality of wires;
partly removing the insulator films as to form apertures on portions of the wire interlaying the wire breakage; and
forming a bypass wire electrically connecting said apertures along a path not overlapping the wire breakage in a plan view.

16. A method for manufacturing an array substrate according to claim 15, further comprising: removing the insulator film on the wire breakage.

17. A method for manufacturing an array substrate according to claim 15, further comprising: forming an organic resin film on said insulator film; and removing the organic resin film at a portion for forming the bypass wire.
